(19) United States
(12) Patent Application Publication
(10) Pub. No.: US 2007/0081163 A1
(43) Pub. Date: Apr. 12, 2007

(54) Method and apparatus for scanned beam microarray assay

(76) Inventors: Minhua Liang, Bothell, WA (US); Bernard G. Murray, Seattle, WA (US); Christopher A. Wiklof, Everett, WA (US)

Correspondence Address: Microvision, Inc., 6222 185th Avenue NE, Redmond, WA, 98052, US

(21) Appl. No.: 11/445,533

(22) Filed: Jun. 1, 2006

Related U.S. Application Data
(60) Provisional application No. 60/687,292, filed on Jun. 3, 2005.

(51) Int. Cl. G01N 21/55; G01N 21/76

(52) U.S. Cl. 356/445; 436/172

(57) ABSTRACT

A system and method provides for chemical and/or biochemical analysis using a microarray interrogated by a resonantly scanned beam of light.

### CROSS REFERENCE TO RELATED APPLICATIONS

This patent application claims priority benefit from U.S. Provisional Patent Application Ser. No. 60/687,292, entitled METHOD AND APPARATUS FOR SCANNED BEAM CHIP ASSAY, invented by Minhua Liang et al., filed Jun. 3, 2005.

### FIELD OF THE INVENTION

The present disclosure relates to methods and apparatuses for conducting light-addressed assays of microarrays, and more particularly to methods and apparatuses for scanned beam interrogation in microarray-based assay systems.

### BACKGROUND

Various technical papers and other publications document methods and apparatuses for conducting optical assays. These include, “Surface Plasmon Resonance Sensors: Review,” by Jiri Homola et al.; “Sensors and Actuators B 54” (1999), Elsevier; “Present and Future of Surface Plasmon Resonance Biosensors,” by Jiri Homola; “Anal Bioanal Chem” (2003); and “Biomedical Photonics Handbook,” Tuan Vo-Dinh, editor-in-chief, CRC Press (2003); all incorporated by reference herein.

The present disclosure provides improvements over the prior art.

### OVERVIEW

According to an illustrative embodiment, a beam of light is scanned across a microarray surface, and the characteristics of light reflected, refracted, and/or emitted from the surface are measured. The microarray surface includes one or more chemical reagents bound to a surface, referred to as a surface reagent. A test fluid is allowed to flow across the microarray surface and one or more components, solutes, etc. are captured by the surface reagent. The captured solutes, which may be tagged or untagged, cause the surface of the microarray to interact with incident light in a characteristic manner. A detector receives light reflected or emitted from near the surface of the microarray. A controller analyzes the received light and determines one or more characteristics thereof. The controller then correlates the one or more characteristics to the chemical or biological attribute of the test fluid.

### BRIEF DESCRIPTION OF THE DRAWINGS

FIG. 1 is a diagram of a prism coupler-based surface plasmon resonance system according to an embodiment.

FIG. 2 is a diagram of a grating coupler-based surface plasmon resonance system according to an embodiment.

FIG. 3A is a cross-sectional diagram of a microarray system responsive to plural patterned surface reagents for selectively attracting the entities from a fluid according to an embodiment.

FIG. 3B is a diagram of an interrogation beam scan pattern across a field of view and across a microarray supported within the field of view according to an embodiment.

FIG. 4 illustrates the attraction of tag and non-tagged entities to a surface reagent according to an embodiment.

FIG. 5 is a block diagram of the scanned beam interrogation system according to an embodiment.

FIG. 6 is a block diagram according to an alternative embodiment that uses a non-imaging detector.

FIG. 7 is a block diagram according to an alternative embodiment that uses a converging input beam.

FIG. 8 is a block diagram according to a multiple wavelength excitation and detection according to an embodiment.

FIG. 9 is a block diagram of a variant of the embodiment represented by FIG. 8 that uses a non-imaging detector according to an embodiment.

FIG. 10 is a block diagram of a variant of FIG. 8 using converging input beams according to an embodiment.

FIG. 11 illustrates a laboratory apparatus for carrying out an embodiment.

FIG. 12 is a view of a beam scanner assembly according to an embodiment.

FIG. 13 is a view of a test cell module according to an embodiment.

FIG. 14 is a view of a focal plane camera showing its relationship to a collection lens according to an embodiment.

FIG. 15 is a plot of intensity vs. time for a single pixel change in intensity arising from a change in refractive index of the dielectric according to an embodiment.

FIG. 16 is a plot corresponding to FIG. 21 where 64×64 pixels were averaged to provide the change in intensity according to an embodiment.

FIG. 17 is a flow chart showing a process for calibrating system response according to an embodiment.

### DETAILED DESCRIPTION

The art often refers to phenomena involved in prior assay systems as surface plasmon resonance (SPR). There may be some debate within the scientific community as to the precise physics involved in these and similar systems. In the interest of clarity, this disclosure generally uses the term surface plasmon resonance as a generic term to refer to such systems and phenomena, even though other physics may be at work. It will be understood that the teaching herein extends to alternative systems.

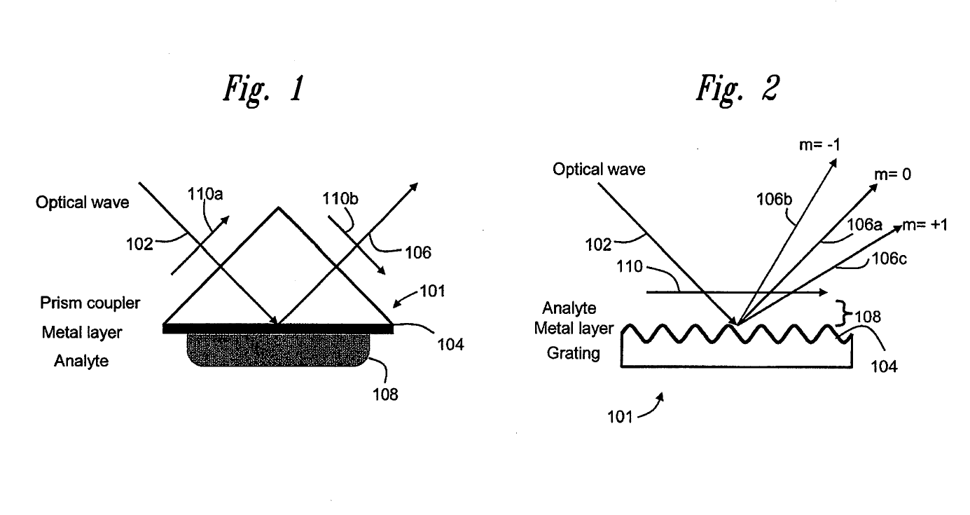

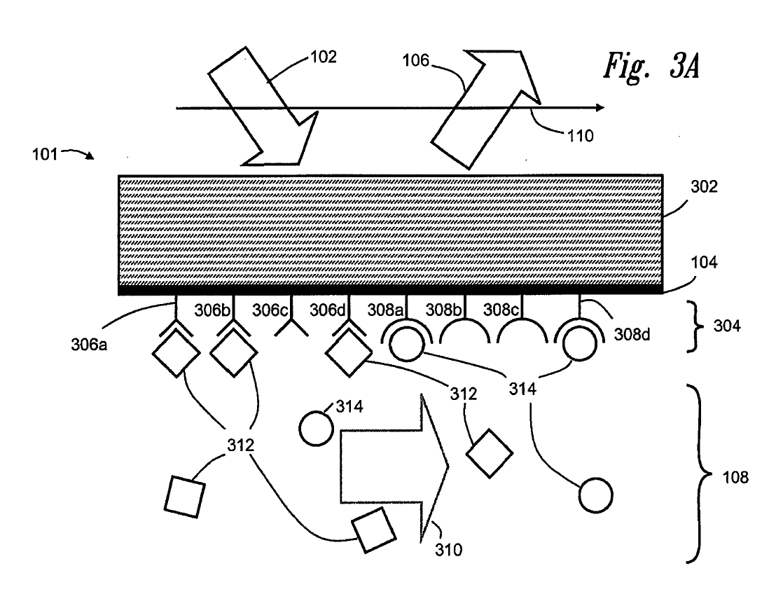

FIG. 1 shows a prism coupler-based surface plasmon resonance system. FIG. 2 shows a grating coupler-based surface plasmon resonance system. In each case, and interrogation beam 102 impinges upon a metal layer 104 of a microarray 101. Metal layer 104 may be formed from gold or silver for example. As is known to the art, the relative tendency of the impinging beam to be guided along the layer in a manner approximating total internal reflection vs. reflecting off the layer depends upon the ratio of the index of refraction of the metal layer to the dielectric layer 304. In turn, the index of refraction of the dielectric (surface reagent) layer 304 depends upon the concentration of test entities held by the surface reagent. Referring to FIG. 1, the strength of the response beam 106 (according to certain interpretations of the physics) depends on the ratio of the index of refraction of the metal layer 104 to the index of refraction of the dielectric (surface reagent) layer 304, and in turn on the concentration of test entities held by the dielectric (surface reagent) layer 304. The structure of the surface reagent layer 304 will be explained more fully below. Referring to FIG. 2, diffraction orders 106a, 106b, and 106c, respectively the zeroeth, −1, and +1 orders, are selectively reflected from the grating surface corresponding to the concentration of test entities on the surface. While only three refraction orders are shown, additional orders may be present.

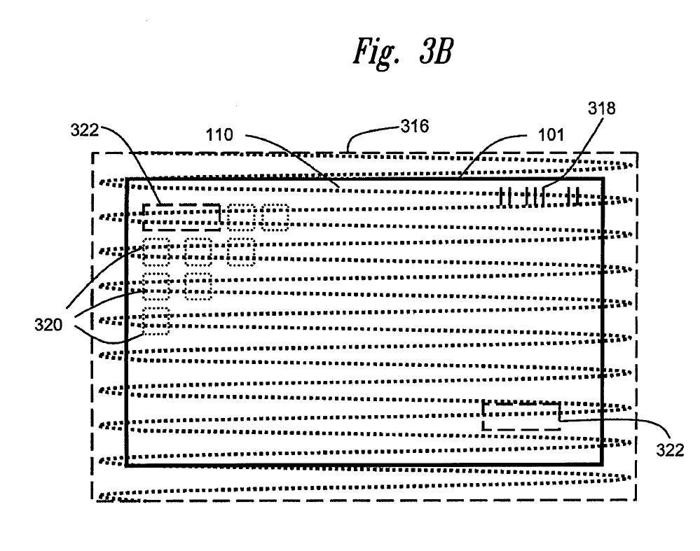

FIG. 3A is a simplified partial cross-sectional diagram of a microarray 101 and test fluid 108. The microarray 101 includes a substrate 302 and a metal layer 104 that has a surface reagent layer 304 comprising two types of surface reagents 306 and 308 for selectively attracting respective entities 312 and 314 from a fluid. In one exemplary embodiment the metal layer is approximately 50 nm thick gold. The interrogation beam 102 is transmitted through the transparent dielectric substrate 302 and impinges on the top side of gold layer 104. A layer of one or more surface reagents 306, 308 coats the bottom surface of metal layer 104 to form the surface reagent layer 304.

According to some embodiments, the surface reagent molecules may include an anchoring end configured to bond to the surface of the microarray, a conductive link that may for example comprise an alternating single-, double-bond carbon chain coupled to the anchoring end, and a reactive end coupled to the conductive link. The reactive end may be selected to provide preferential coupling with a test entity.

The test fluid 108 flows past the surface reagent layer 304 as indicated by the arrow 310. In this example, the test fluid 108 includes two types of test entities 312 and 314, which may for example be proteins, DNA strands, other molecules, etc. In the example of FIG. 3A, two types of surface reagents 306 and 308 are shown patterned onto the surface of metal layer 104 to form the surface reagent layer 304. The surface reagent molecules identified as 306a, 306b, 306c, and 306d are selected to attract a first type of entity 312. As shown in FIG. 3A, surface reagent molecules 306a, 306b, and 306d are filled by respective entities 312 and surface reagent molecule 306c is empty. Similarly, surface reagent molecules identified as 308a-d are selected to attract test entities 314 from test fluid 108. Surface reagent molecules 308a and 308d are shown filled with test entities 314 and surface reagent molecules are shown empty. According to some embodiments, surface reagents may be selected to fill proportionally to the concentration of respective test entities in the test fluid 108. Accordingly, the ratio of filled sites of surface reagent 306 to filled sites of surface reagent 308 (optionally when modified by one or more conversion factors), may be proportional to the relative concentrations of test entities 312 and 314 in the test fluid 108. Conversion factors may include compensation for relative attraction (e.g. electro-negativity ratios), diffusivity, geometric factors, temperature, flow rate, Reynolds number, miscibility, etc. that may change the particular relationship between concentration and proportion of filled surface reagent sites.

While the microarray 101 is held in a field-of-view (FOV), the interrogation beam 102 is scanned across the microarray in a scan path 110. A portion of the incident interrogation beam 102 may be reflected, scattered, emitted, etc. as a response beam 106. According to some theories, the tendency for reagent molecules 306, 308 to resonate at the interrogation wavelength may be modified by the presence or absence of captured test entities. The relative resonance of the reagent molecules affects the transmission, reflection, etc. of the response beam 106. According to some theories, whether surface reagent sites 306, 308 are filled or unfilled determines that index of refraction of the system, and accordingly determines the strength of the response beam 106. Thus, the intensity of the response beam 106 may be proportional to the proportion of filled sites within the traversed portion of the microarray.

In addition to or alternatively to using the intensity of the response beam 106 to measure the state of the reagent sites 306, 308, other electromagnetic response characteristics may be measured to provide a measure of surface concentrations. For example interrogation beam wavelength sensitivity, wavelength shift between the interrogation and response beams, polarization state, etc. may be detected and correlated to surface concentrations.

As described more fully below, a microarray substrate 302 may be loaded with one or a plurality of types of surface reagents 306, 308. Alternatively, the concentration, relative activity, etc. of a particular surface reagent may be modified across the surface reagent layer 304. Such varying surface reagents may be patterned across the surface to provide a broader spectrum of detection, greater dynamic range, greater sensitivity, greater specificity, etc. Interfaces between particular surface reagents 306, 308 may be selected to provide preferential coupling to different parts of particular or related molecules. Such an approach may be used to provide specificity to isomers, bring reactants into a desired proximity and/or orientation, etc.

FIG. 3B illustrates a scan path 110 across a microarray 101 held in a field-of-view 316. In the illustrative embodiment, the scan path may be a two-dimensional pattern sequentially scanned by the interrogation beam. The 2D pattern may be scanned in a periodically repeating manner to provide successive frames of response from the microarray. According to some embodiments, the frames may be repeated at a video rate such as 60 Hz to provide dynamic detection of changes in surface concentration of test entities. In embodiments where the microarray is patterned with cells 320 of varying surface reagent properties (several of whose positions are indicated), beam location may be correlated to a set of test criteria associated with the surface reagent property in the location.

The microarray 101 is shown bearing an indicia 318 that may be scanned by the interrogation beam. According to some embodiments, the indicia may be a linear or 2D bar code symbol that provides orientation, calibration, and/or other characterization data for the microarray. According to some embodiments, a single-width, variable placement symbology such as BC 412, etc. may be used.

The symbol may directly encode orientation, calibration or characterization data. Alternatively the symbol may encode a serial number, lot code, etc. that may be used as an access code to lookup relevant orientation, calibration or characterization data.

The scan pattern or path 110 is illustrated as a pattern corresponding to a resonant bi-directional horizontal scan superimposed over a smooth vertical ramp. Accordingly, raster pinch may be seen at the lateral extremes of the scan pattern. The microarray 101 is illustrated as occupying a portion of the field of view 316 with over-scan regions at each lateral extreme as well as optional over-scan regions at each vertical extreme. Provision for such over-scan regions may be desirable to reduce the degree of raster pinch and hence deviation from parallel horizontal scan lines. Additionally or alternatively, interpolation, correction scanning, etc. may be included to provide a respective virtual or real scan pattern that more nearly approaches straight horizontal scan lines.

One or more calibration patches 322 may be included. The calibration patches may be configured to maintain a constant beam response such as, for example, by excluding surface reagents or providing non-reactive surface reagents therein. As will be explained later, the calibration patches may be used to calibrate system response such as, for example, variations in illuminator power output. Such calibration may be used to reduce noise and provide more accurate tracking of variations in the system and therefore more accurate determination of test patch response.

The scan pattern 110 provides sequential addressing of the surface of the microarray 101. Thus a sequentially addressed, non-imaging detector may be used to detect the response beam 106, with spatial information being provided by the time sequential pattern of the scanned beam.

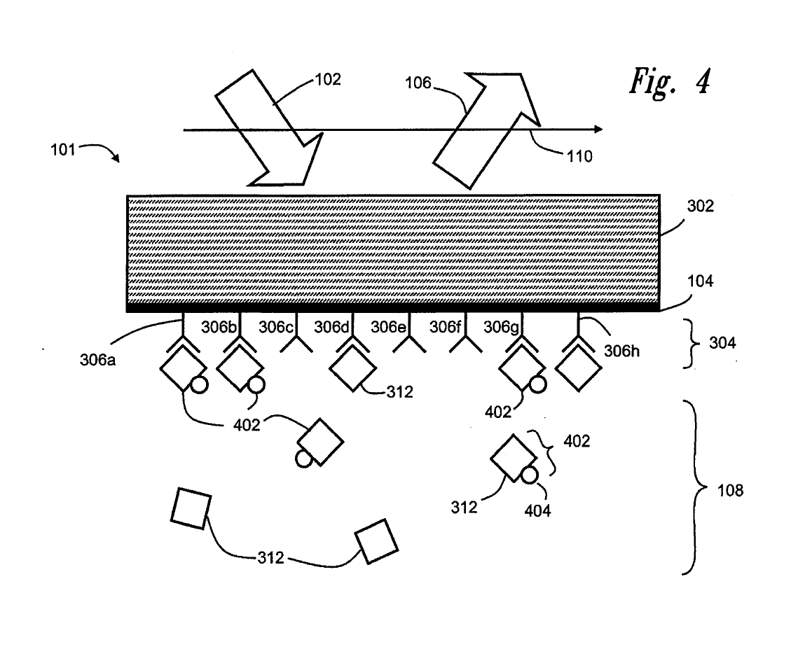

FIG. 4 illustrates the attraction of tagged and non-tagged entities to a surface reagent. As with the example of FIG. 3, substrate 302 supports a metal layer 104 which holds surface reagents 304. As the test fluid 108 flows past, the surface reagent molecules attract respectively tagged and untagged entities 402 and 312. As shown, tagged entities 402 are bound or otherwise associated with a tagging entity 404. In the example of FIG. 4 and elsewhere herein, tagging entities 404 may be photoluminescent entities adapted to absorb a first wavelength of light and responsively emit a second wavelength of light. As will be shown below, one aspect of some embodiments is the ability to simultaneously or in rapid succession determine the presence or absence of test entities 312/410 on surface reagent 304 and the presence or absence of tags 404.

According to some embodiments, photoluminescence may be used as a proxy for SPR interrogation. That is, the photoluminescence of the fluorescent tags may be used to determine the presence/absence/concentration of entities to which the tags are affixed. Similarly, in addition to responses to an incident light beam, chemiluminescence may be determined.

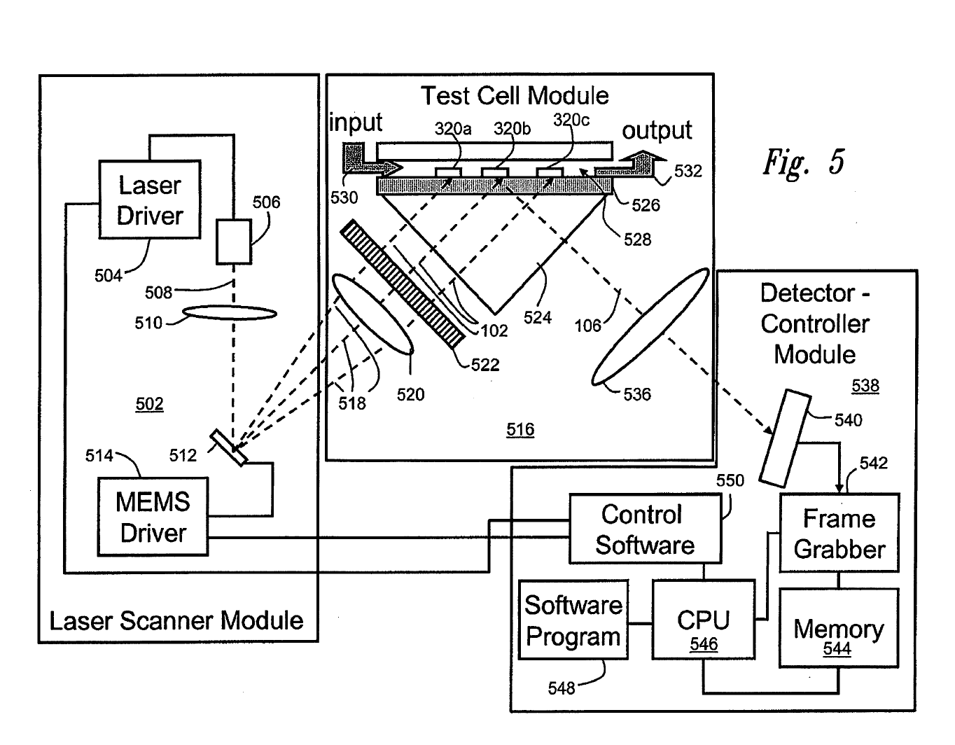

FIG. 5 is a block diagram of a scanned beam interrogation system according to an embodiment. A laser scanner module 502 includes a laser driver 504 that drives a first laser 506. A beam of light 508 emitted by the first laser 506 is shaped by beam shaping optics 510 and impinges upon a scan mirror 512. According to some embodiments, scan mirror 512 may be a MEMS scanner that is driven by a MEMS driver 514 also present in the laser scanner module 502. According to exemplary embodiment the laser 506 emits coherent light at 658 nm wavelength at a power range of 0 to 25 milliwatts.

The scanner module 502 is aligned with the test cell module 516 such that the scanned light beam 518 (shown in three illustrative positions) is collimated by a lens 520. A linear polarizer 522 polarizes the light to couple with the microarray (described below) in TM (or P) mode. Sequentially scanned parallel beams of light 102 enter a coupling prism 524 and impinge upon the surface of the microarray 526 as described and shown above. The test fluid space 528 has provision for flow of a test fluid from an input 530 to an output 532. According to some embodiments a plurality of inputs and outputs are used. According to an illustrative embodiment, the microarray includes a plurality of test patches 320a, 320b, and 320c, each of which may be loaded with a different particular surface reagent. As described above, impinging beams 102 are reflected or absorbed by regions of the metal/dielectric corresponding to the test cells on the microarray according to the presence or absence of test entities in surface reagent sites. In surface plasmon resonance mode, impinging light rays 102 are reflected (or not reflected) as reflected rays 106 through the coupling prism 524 to a collecting lens 536. Similarly, photoluminescent emission from test cells 320a, 320b, and 320c may also output at least a portion of its energy to collecting lens 536.

Test patches 320 may be reduced to a single patch, may be arranged in a one-dimensional pattern such as a series of stripes, may be arranged in a 2D rectilinear or “checkerboard” pattern, or in other patterns. The microarray may be aligned with its test patches facing toward the light beams 102 as shown, or alternatively may be turned to face in the opposite direction such that the light beams first pass through a transparent substrate. In the latter case, the substrate may be made separate or integral with the coupling prism 524. A range of test patch sizes may be used according to the requirements of a given application. For example, a single-patch microarray may be arranged with the single patch imaged across the entire field of view of the scanner module 502 and detector/controller module 538. This may be useful, for example, when adsorption or reaction rate data is desired to be collected (for which some embodiments may be used). Alternatively test patches corresponding to a single pixel may be used. Patch sizes of 1×1 (pixel), 2×2, 4×4, 8×8, 16×16, 32×32, and 64×64 have been simulated from data taken from a single, multiple pixel (covering substantially the entire field-of-view) cell microarray. Additionally, a square aspect ratio need not be maintained.

The collection optic 536 is configured to focus the response beams 106 onto the focal plane array 540. In this case, it may be appropriate to align the focal plane detector 540 parallel to the collection optic and to select focal distances such that the distance from the collection optic 536 to points on the microarray 526 corresponding to the test patches 320 falls within the depth-of-field of the system. According to some embodiments, the focal length of the collection optic 536 may be varied dynamically to keep the current location of the interrogation beam 102 in focus. According to some embodiments, a scattering screen, photoluminescent (PL) screen, etc. may be formed on the output face of the coupling prism 524 such that the collection optic 536 focuses the scattered image from the coupling prism output face onto the focal plane detector 540. While the collection optic 536 is simplified to show a single lens, it may include multiple elements including elements such as lenses, mirrors, and diffractive elements.

According to some embodiments, the scan pattern of the scanner module 502 may be varied as a function of aspects of the microarray 526 and the test cell or cells 320 thereon. For example, fiducials, bar codes, etc. 318, as shown in FIG. 3B, may be formed across or around the periphery of the microarray for providing accurate alignment, calibration and/or characterization information about a particular microarray. Characterization traits that may be determined include the arrangement and type of test patches, the spacing of the test patches, the spectral response characteristics of the test patches, the coupling length of the test patches, the surface reagent characteristics of the test patches, etc. The detector and controller systems (described below) determine the characterization, calibration, and/or alignment of the microarray and may responsively drive the scanner module 502 to a modified scan pattern. Alternatively, the scan pattern may be maintained substantially constant while the sampling of the detector system (described below) is modified to allow for microarray characteristics. Alternatively, the characterization data may be used to select conversion data in the software program 548 described below, log inventory or use of a microarray, or act as input to provide other functions.

As indicated by the example of FIG. 5, a scan mirror 512 sequentially scans output beam 518 and hence interrogation beam 102. That is, the beam 102 is scanned onto test patch 320a at a first instant in time, and onto test patches 320b in 320c that other instants in time. As shown, the surface state of test patches 320a and 320c is such that substantially no response beam 106 is produced, while the surface state of test patch 320b cooperates with the incoming interrogation beam to create a response beam 106. While this simplified response may be substantially the manner in which a given microarray responds under a set of conditions, it may also be the case that some amount of response beam is present from each test patch with the relative attenuation varying according to the (empty or full) state and proportion of the surface reagent molecules within each test patch.

A detector/controller module 538 is aligned to receive light from the collecting lens 536. Reflected beam 106 passes through collection lens 536 and impinges on a CCD, CMOS, or other focal plane detector 540. A frame grabber 542 receives the image from the focal plane detector 540 and transfers it to memory 544. A microprocessor or other central processing unit 546 controls memory 544 and frame grabber 542 and is configured to run a software program 548 that calculates the presence or absence and/or concentration of test entities in the test fluid 528, decodes indicia on the microarray, and/or performs other functions. Controller 538 also includes control software 550 for controlling the laser driver 504 and the MEMS driver 514 within the laser scanner module 502. Alternatively concentration, presence, or absence of entities may be calculated in a separate computer system.

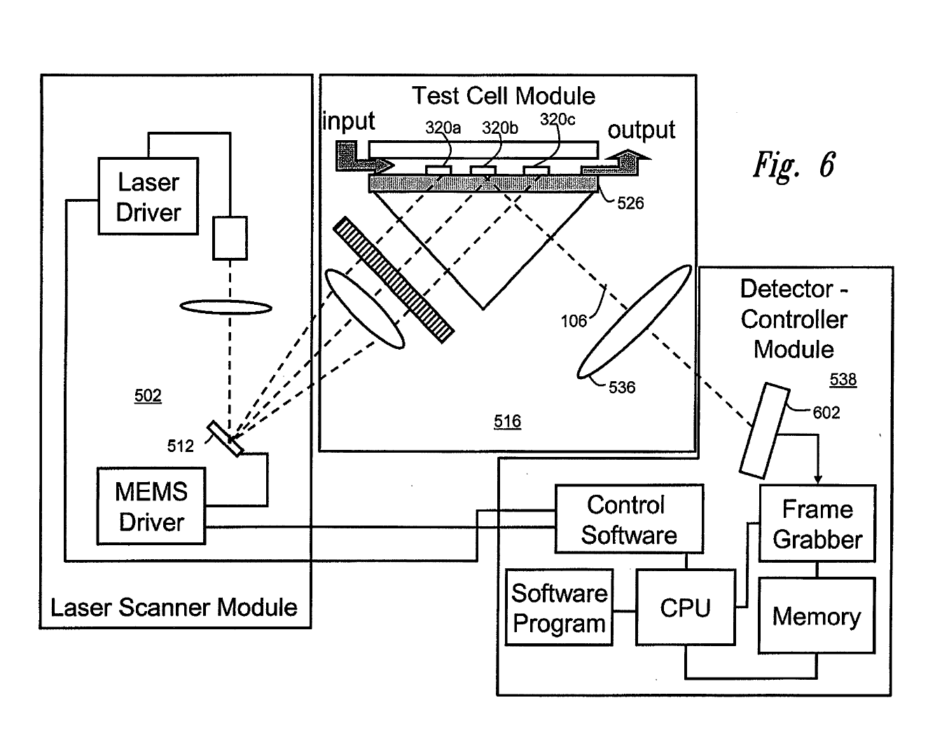

FIG. 6 illustrates an alternative detector system that uses a non-imaging detector 602 to capture the instantaneous light received from the test cells. As indicated above, the scan mirror 512 sequentially addresses the test patches 320a, 320b, and 320c (here shown in an exemplary manner with the surface reagent facing the input beam). Thus according to some embodiments light from the test patches need not be imaged by focal plane detector. Rather, the timing of light received by the photodetector is correlated to the instantaneous mirror position to determine which test patch corresponds to the currently received light. A collection optic 536 may be used to increase the numerical aperture over which a scattered or reflect response beam 106 is collected. In some embodiments, the collection optic 536 may comprise a telecentric lens aligned to converge parallel response beams from across the microarray 526 onto the detector 602.

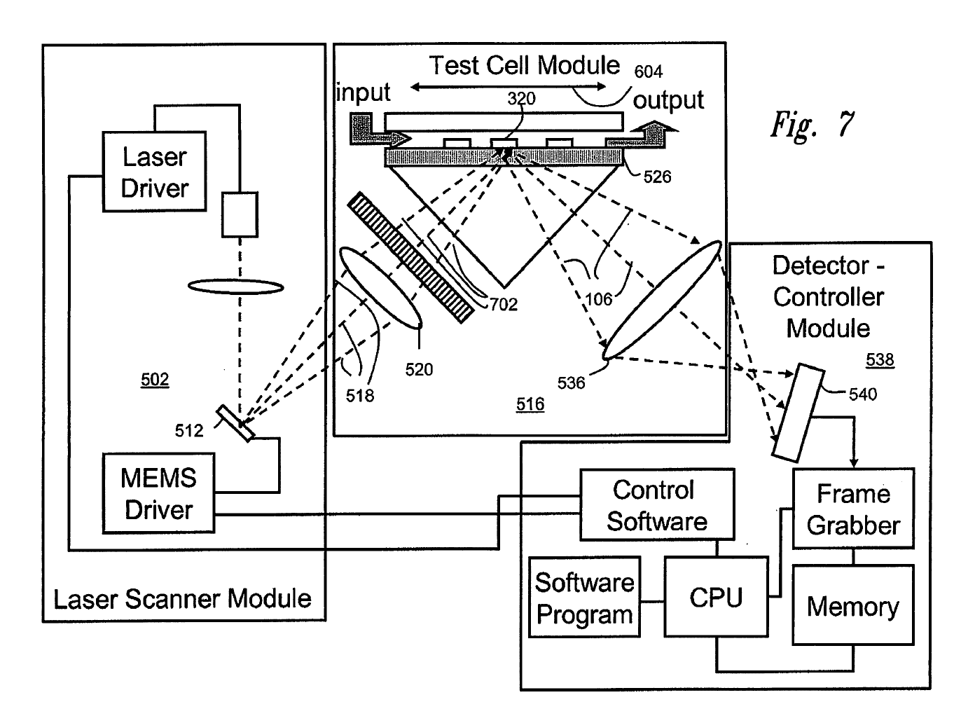

FIG. 7 is a block diagram according to an alternative embodiment wherein one or more lenses 520 is (are) operable to receive a sequentially scanned beam 518 and produce corresponding sequentially scanned converging beams 702. In this way, a given test patch 320 on the microarray 526 receives light at a variety of input angles over successive instants in time. Light reflected at the respective instants in time 106 is imaged onto the focal plane detector 540 by collection optic 536, or alternatively onto a non-imaging photodetector 602 (not shown). When using a non-imaging photodetector, the instantaneous beam position may be used to map the response from a variety of collection angles as described in conjunction with FIG. 6, above and the collected light may be collected over a relatively narrow aperture to determine the reflectance angle. The system of FIG. 7 may be configured to determine the characteristics of the test patch as a function of impinging light angle. For example, as the index of refraction changes slightly, the angles of which detection rays 704 are reflected change. Thus, the intensity pattern of light moves across the surface of focal plane imager 540. In addition to systems using a single lens 520, a plurality of lenses, such as a microlens array for example, may be used. Such a system is operative to introduce a variety of input angles to a plurality of test patches. In such a case, it may be useful for the microlens array 520 to be made interchangeable to allow arrangements of lenses corresponding to a variety of arrangements of test patches 320 may be used.

Alternatively, the microarray 526 may be stepped across the FOV as indicated by arrow 704 to sample reflection angles from a plurality of test patches 320 or from a plurality of locations on a test patch 320.

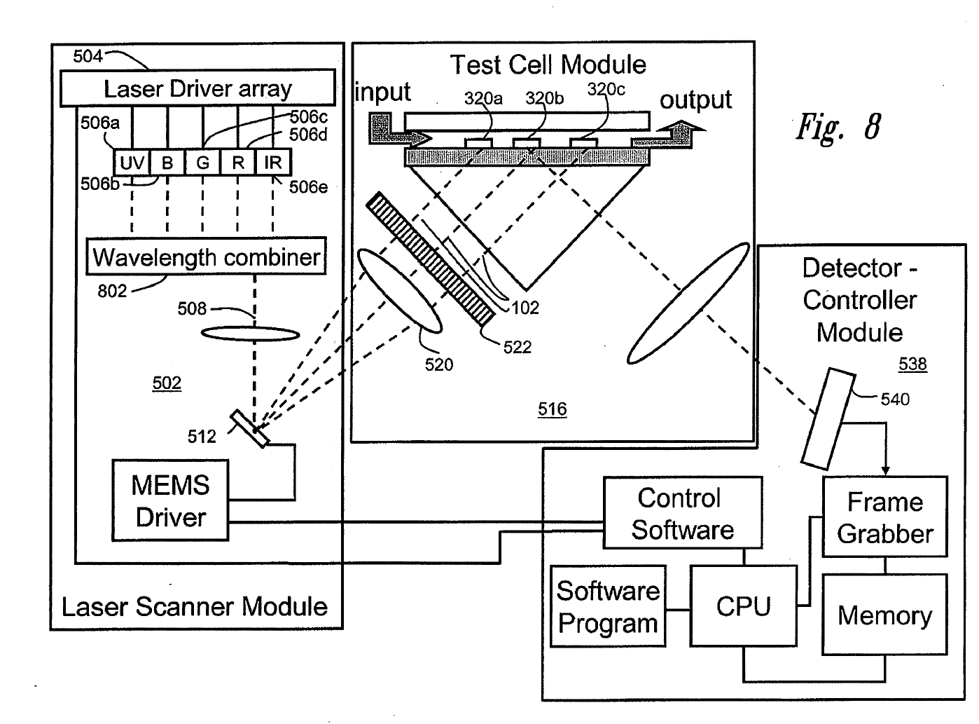

FIG. 8 is a block diagram according to a multiple or flexible wavelength embodiment of the system. According to the illustrative embodiment, the laser scanner module 502 may include a plurality of laser drivers 504, here shown as an array, drive a plurality of lasers 506a, 506b, 506c, 506d, and 506e. The plurality of lasers produce a plurality of colored laser beams that are combined into a single beam 508 by a beam combiner 802. According to the illustrative embodiment, laser 506a corresponds to an ultraviolet (UV) wavelength, laser 506b corresponds to a blue (B) wavelength, laser 506c corresponds to a green (G) wavelength, laser 506d corresponds to a red (R) wavelength, and laser 506e corresponds to an infrared (IR) wavelength. The input beams are introduced to a wavelength or beam combiner 802 and the beam combiner 802 produces a composite beam 508 containing the respective wavelengths at their respective powers. By driving the laser array, light at selected wavelengths may be made to impinge on the test patches 320. Alternatively or additionally, one or more wavelengths may be selected to produce photoluminescence of tags as described above. As illustrated, reflected, photoluminescently emitted light, and/or chemiluminescently emitted light is imaged by focal plane imager 540, or alternatively by a non-imaging photodetector as described above.

According to an alternative embodiment, one or more wavelength agile lasers, which may optionally be combined with additional channels of fixed wavelength or variable wavelength lasers, may be driven to produce particular wavelengths of light.

According to some embodiments a composite beam 508 is scanned by the MEMS scanner 512 to form a sequentially scanned interrogation beam 102 that includes the plurality of wavelengths. Alternatively, the lasers 506 may be sequentially driven to provide an interrogation beam that contains one wavelength while interrogating a given test patch 320a. A different laser may then be driven during interrogation of a second test patch 320b, etc. Alternatively, a plurality of wavelengths less than the total number of channels may be used to interrogate a given test patch 320. Accordingly, an analysis of variance between wavelength response of test patches may be conducted with confounding of higher order interactions selected to improve system throughput.

Alternatively, the plural or flexible laser(s) of FIG. 8 may be used to provide other variations in the input beam. For example, the polarizer 522 after lens 520 may be omitted and the laser beams may be polarized prior to combining. Thus, a variety of beam polarizations may be introduced to the microarray. This may be used for example for experimental analysis and/or to accommodate slight misalignments in the system to maintain (for example) TM polarization at the metal surface 104.

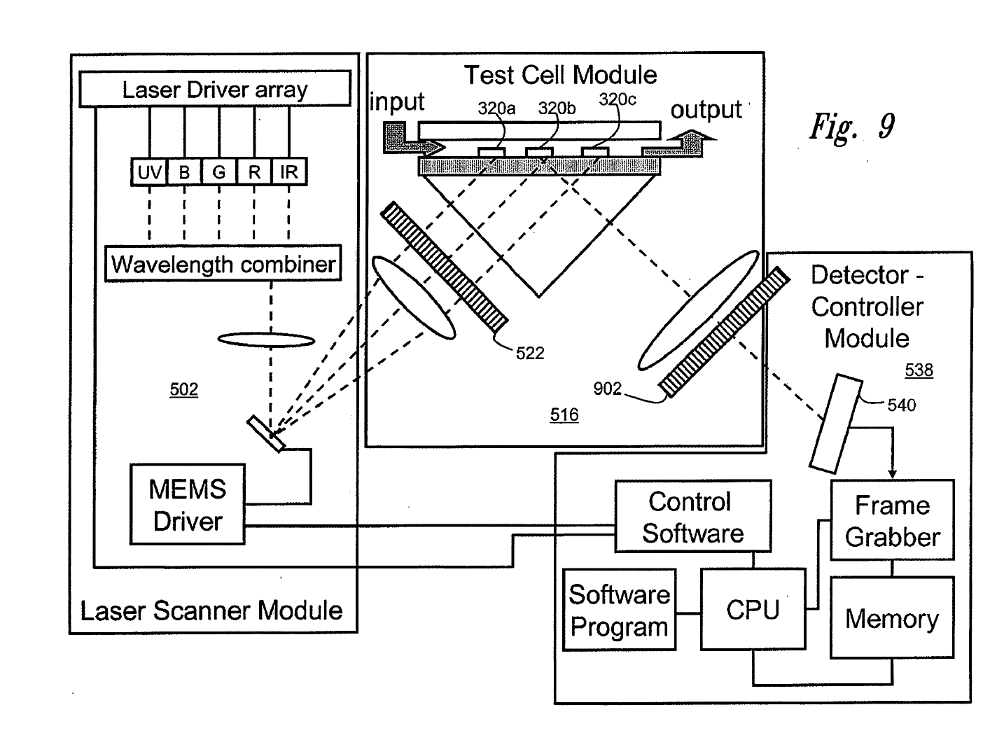

FIG. 9 is a block diagram according to a variant of an embodiment of FIG. 8 wherein an analyzer 902 is used to detect rotation of polarization imparted by the polarizer 522. Polarization rotation may be affected by the state of the test patches 320. Such a system may be operable with a single wavelength laser scanner module 502 or a multiple wavelength system as illustrated. In multi-wavelength systems, the amount of polarization rotation as a function of wavelength may be used to provide an interrogation modality.

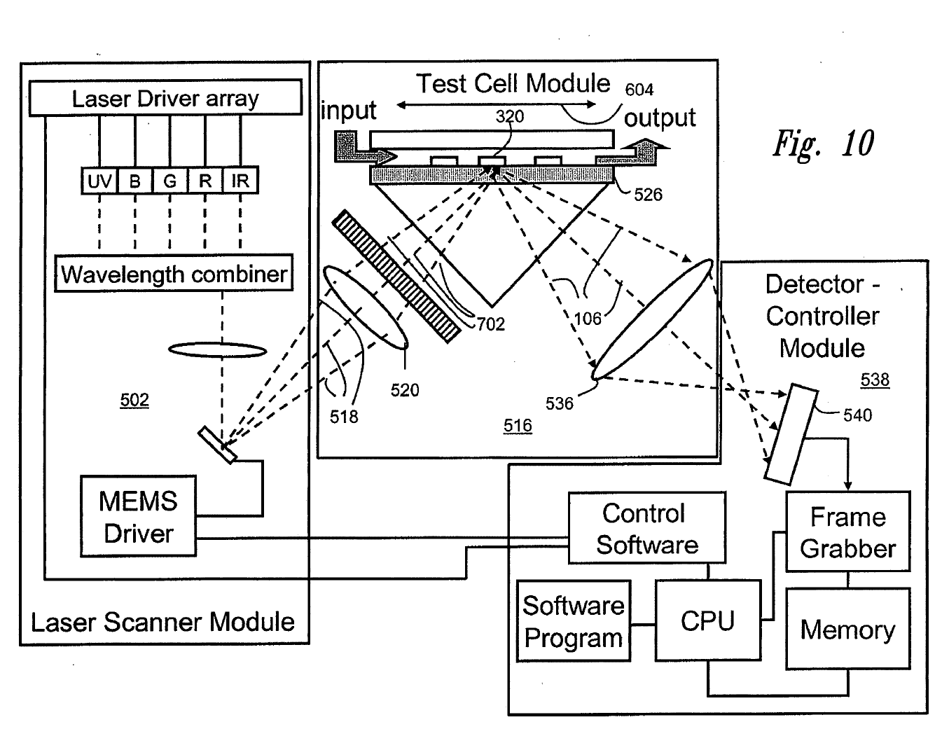

FIG. 10 illustrates a variant wherein a scanner module 502 includes plural wavelengths or wavelength agile beams that are focused by optical element 520 to converge on a test patch 320 as converging interrogation beams 702. As with the illustrative embodiment of FIG. 7, an array of optical elements 520 may be used to produce an array of converging beam test points coincident with the microarray 526. It may be advantageous for certain applications to substitute one or more reflective or diffractive optical elements for the lens 520. Reflective optical elements in particular are known to minimize chromatic distortion and may be especially useful with a multiple wavelength system.

Response beams 106 at various angles may simultaneously or sequentially include a plurality of wavelengths for detection by the detector 540 in the detector-controller module 538. As with the example of FIG. 7, the test cell module 516 may include a mechanism for stepping the microarray 526 past the interrogation point to sequentially interrogate a plurality of test patches 320 or a plurality of spots on a test patch 320.

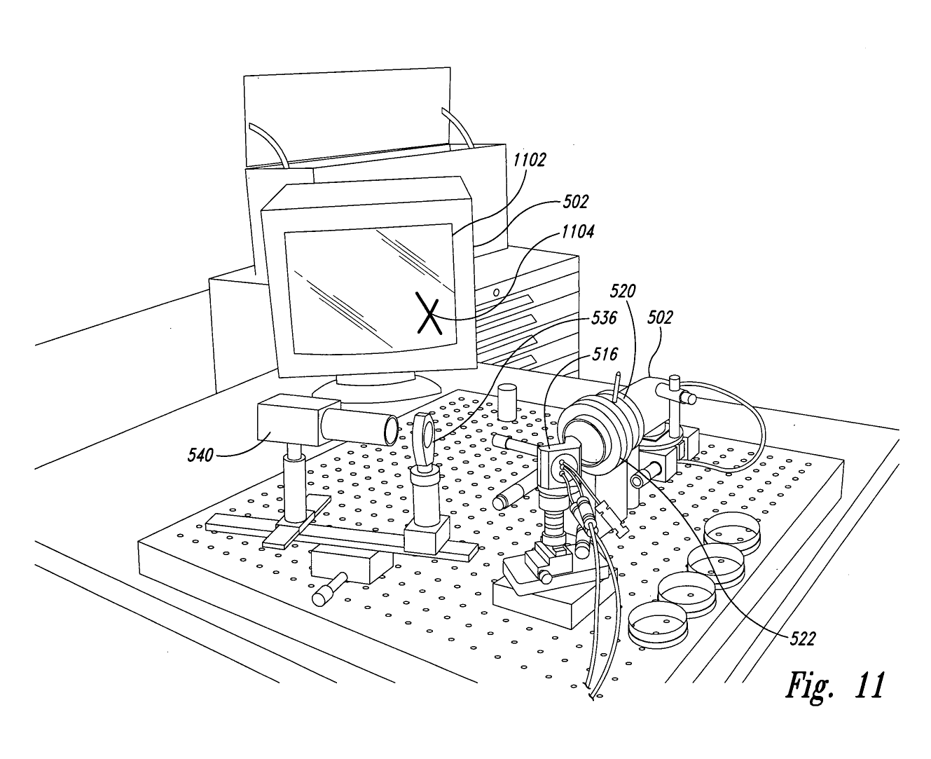

FIG. 11 illustrates a laboratory microarray interrogation apparatus according to an embodiment. The scanner module 502 is aligned to scan a beam through a lens 520 and polarizer 522 onto the test module 516. Light is selectively reflected from the surface of the microarray according to principles described above. The selectively reflected light is collected by a collection lens 536 and imaged by a focal plane camera 540. A computer monitor 502 displays an image of the microarray 1102 including a fiducial 1104 for determining alignment.

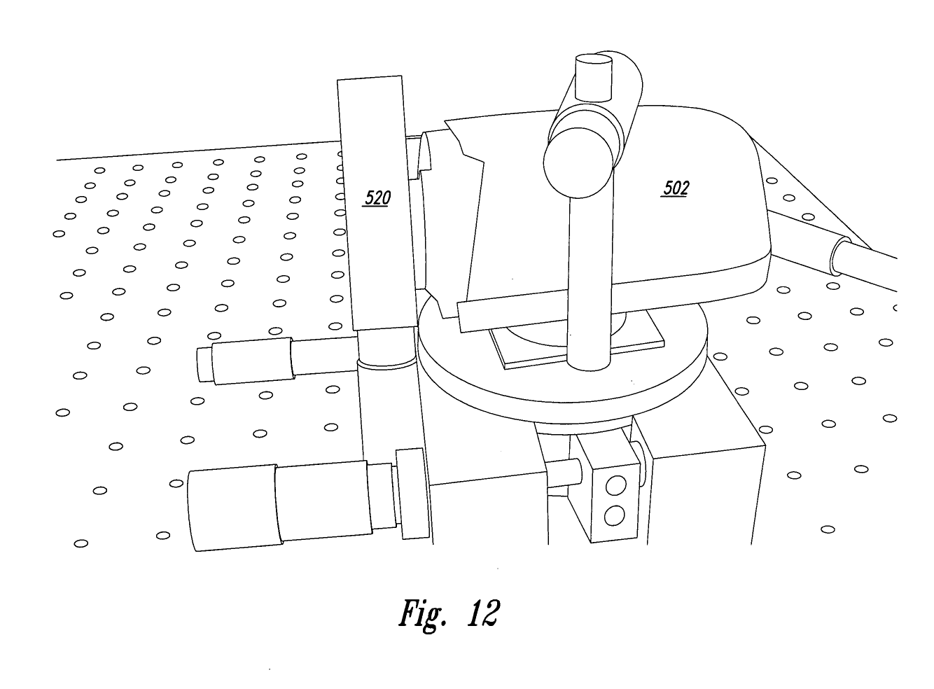

FIG. 12 is a close-up view of the beam scanner assembly 502 aligned to scan a beam of light through a lens 520.

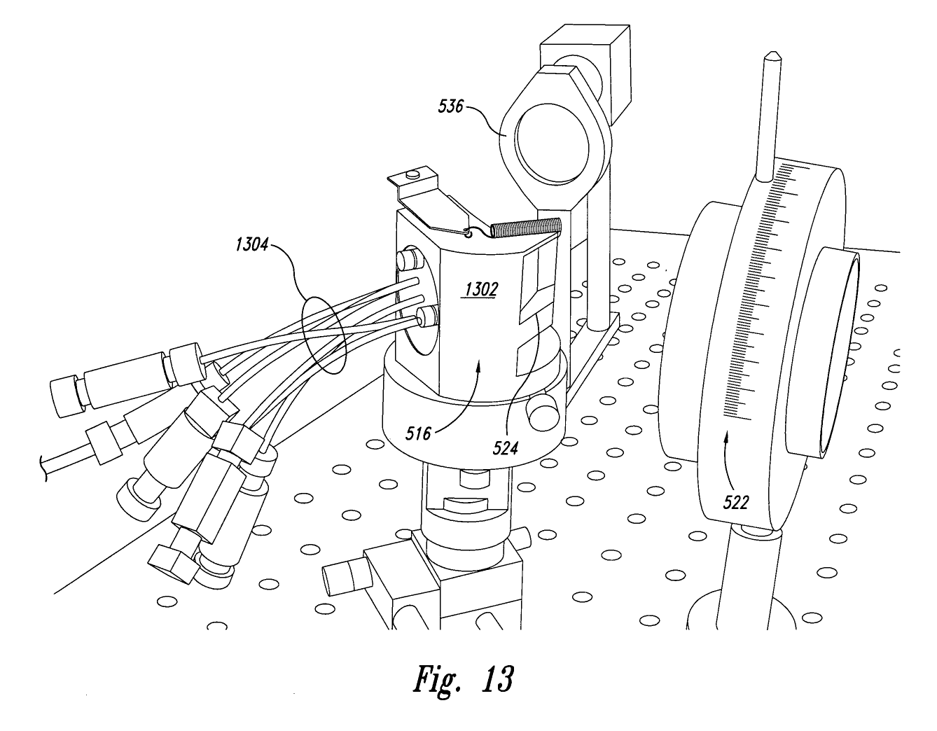

FIG. 13 is a close-up view of the test cell module according to an embodiment. The test cell module 516 includes a body 1302, a coupling prism 524, and fluid introduction and removal lines 1304. Also shown is a polarizer 522 through which the interrogation beam is received according to some embodiments, and a collection lens 536 aligned to receive response beams from the microarray held by the body 1302 of the test cell module.

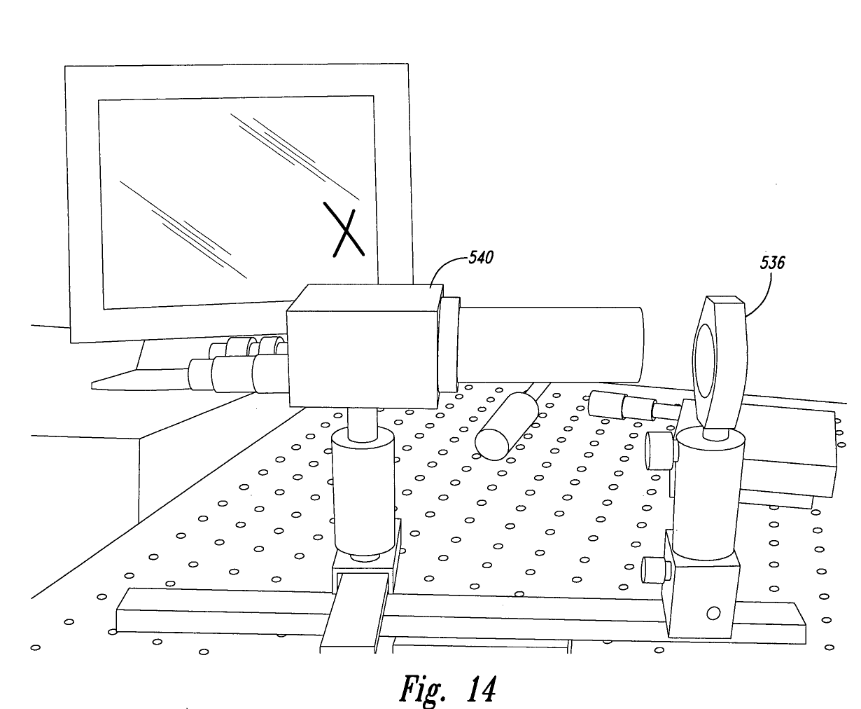

FIG. 14 is a close-up view of the focal plane camera 540 showing its relationship to a collection lens 536 according to an embodiment.

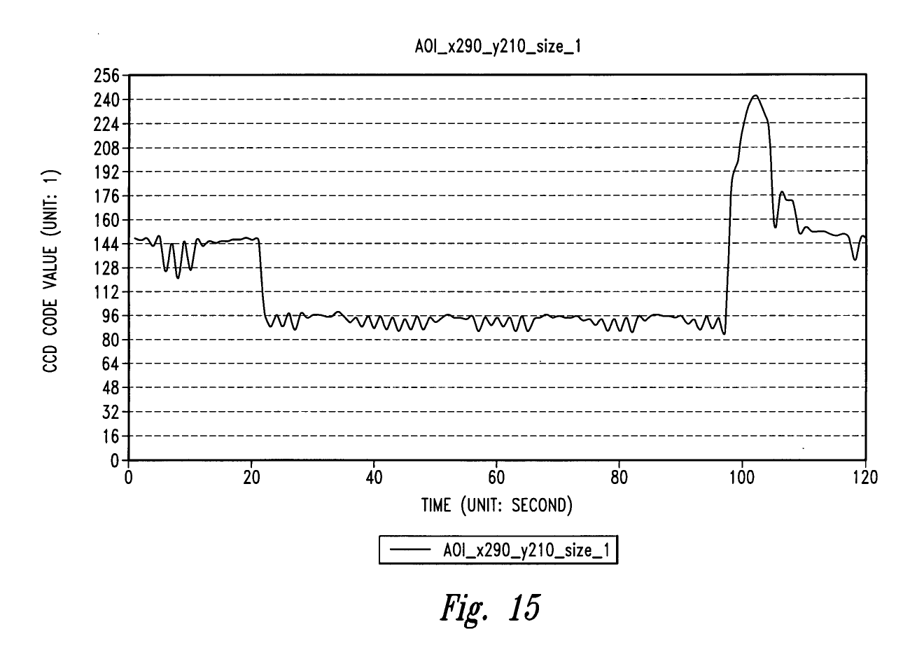

FIG. 15 is a plot of laboratory data taken with the system illustrated by FIGS. 11-14. FIG. 15 shows the change in light intensity received by a single, particular pixel on the detector as a function of time. The time plotted corresponds to the addition of a dielectric index changing material through the flow lines to the test fluid.

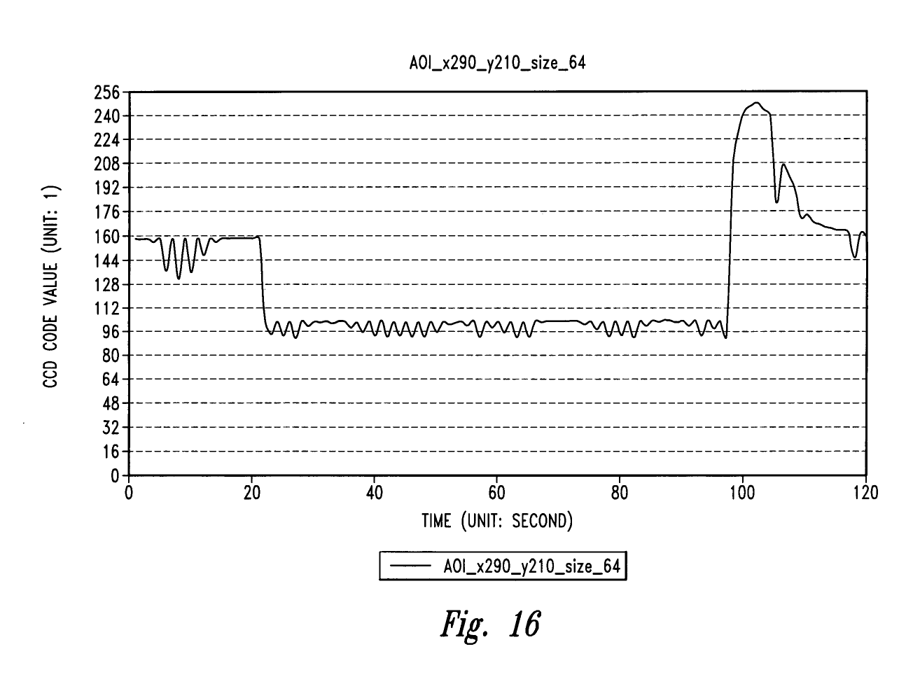

FIG. 16 is a plot of laboratory data corresponding to FIG. 15, but where the plotted data is the average of a 64 by 64 pixel region.

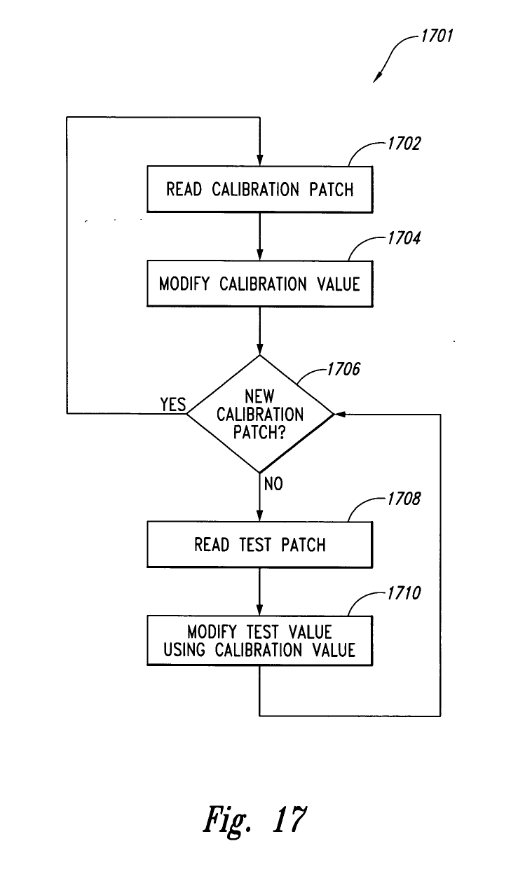

FIG. 17 is a flow chart describing a method for calibrating system response that, according to an embodiment, may be performed by the software program 548 running in the controller, or optionally may be run by a computer used to record and/or analyze the results of a test. Laser gain curves, detector sensitivity, amplifier gain, and other system variables may change with time, temperature, power fluctuations, etc. Experiments have shown that laser gain may be the largest of such changes, especially when certain laser technologies such as second harmonic generation (SHG) lasers are used. Such changes may result in concentration-to-code relationships that are non-constant. Measurement of the system response to areas of known SPR may be used to compensate for such system variables.

As described above and shown in FIG. 3B, a microarray may include one or more calibration patches 322. The calibration patches may for example include a non-reactive surface agent whose SPR response is not affected by concentrations in the test fluid. The calibration patches may be formed in one or more locations on the microarray. Alternatively or additionally, calibration patches may be formed in the field-of-view of the scanned beam outside the perimeter of the microarray such as in the overscan region. The relationships between calibration patches formed on the test cell module body and calibration patches on the microarray, between calibration patches formed on the test cell module body and test patches on the microarray, and/or between calibration patches formed on the microarray and test patches on the microarray may be used to provide system calibration. One or more of the test patches may provide a response corresponding to a zero response. Another test patch may provide a response corresponding to a full scale response such as a mirror surface for example.

Referring to the flow chart 1701 of FIG. 17, the beam is scanned in a pattern and encounters a calibration patch and enters step 1702. The response of the calibration patch is cached. Step 1702 may optionally include averaging a plurality of response pixels. After caching the response, the program enters step 1704. According to some embodiments, step 1704 may involve simply overwriting a previously stored calibration value with the most recently cached value. According to other embodiments, step 1704 may involve applying a statistical algorithm such as updating the stored calibration value with an average or weighted average of the previously stored value and a recently determined value. Proceeding to step 1706, the system determines whether a new beam position in the scan pattern corresponds to a calibration patch or to a test patch. If the beam position corresponds to a calibration patch, the program loops and returns to step 1702. If the beam position corresponds to a test patch, the program proceeds to step 1708.

As mentioned above, a microarray and/or test cell module body may include a plurality of test patches. According to some embodiments, the location and/or size of test patches may be determined by reading an optical indicia on the microarray or on the microarray package.

Proceeding to step 1708, the interrogation beam is scanned over a test patch and the response measured. After caching the response, the program proceeds to step 1710. In step 1710, the code value measured in step 1708 may be modified according to the stored calibration value. For example, the measured value may be modified by dividing by the difference between the stored calibration value and a nominal value, wherein the nominal value represents the value that would be returned from the calibration patch if all system components were responding at their intended levels.

I.e.:
Corrected Value=Measured Value/(Calibration Value−Nominal Value)

In this way, if the response of the system is higher than nominal, for example because the laser has output a brighter beam than nominal, the calibration value will be larger than the nominal value and the denominator will be greater than one. Dividing the measured value by the denominator will reduce the measured value to a corrected value that corresponds to nominal system response. The corrected value is then output to an output file, a computer monitor, a data plotting program, etc.

After performing step 1710, the program loops to decision step 1706 and again determines whether the currently illuminated point on the microarray corresponds to a test patch or a calibration patch. The program proceeds according to the state.

The inclusion of a plurality of calibration patches may be used to determine systematic response of the system vs. beam position and/or provide multiple updates per image frame to account for system response variations across a range of frequencies.

Aspects of the beam scanner module, detector module, and/or controller and operation thereof may be better understood by reference to one or more of U.S. Pat. No. 6,140,979 by Gerhard et al.; U.S. Pat. No. 6,151,167 by Melville; U.S. Pat. No. 6,245,590 by Wine et al.; U.S. Pat. No. 6,362,912 by Lewis et al.; U.S. Pat. No. 6,433,907 by Lippert et al.; and U.S. Pat. No. 5,629,790 to Neukermans et al.; all hereby incorporated by reference. This disclosure may be further understood by reference to one or more of U.S. patent application Ser. No. 10/873,540 by Wiklof et al.; U.S. patent application Ser. No. 10/984,327 by Sprague et al.; U.S. patent application Ser. No. 10/630,062 by Wiklof et al.; U.S. patent application Ser. No. 10/118,861 by Bright et al.; U.S. patent application Ser. No. 11/316,683 by Skumik et al.; and U.S. patent application Ser. No. 11/316,326, by Straka et al., all hereby incorporated by reference.

The preceding overview, brief description of the drawings, and detailed description describe exemplary embodiments according to the present invention in a manner intended to foster ease of understanding by the reader. Other structures, methods, and equivalents may be within the scope of the invention. For example, methods and physical embodiments may be combined or used singly.

Additionally, while terms such as “laser scanner module” and “laser emitter” have been used to describe embodiments, it is possible to provide a beam scanner that produces light from sources other than lasers. Such sources may include, for example, photoluminescent sources, incandescent sources, arc emission sources, light emitting diodes, etc. Similarly, lasers may include a number of different technologies include laser diodes, second harmonic generation lasers, gas lasers, etc. Accordingly, except where noted, terms such as “beam scanner module” and “beam source” should be regarded as functional and structural equivalents of corresponding terms such as “laser scanner module” and “laser source”.

Further, while embodiments described herein refer to a modularity comprising a scanner module, a test cell module, and a detector-controller module, other groupings of components should be viewed as structural and functional equivalents. For example, some or all components may be included as part of an overall assembly having no overt modularity per se. Alternatively, the controller may be included locally or remotely; or may be grouped with the scanner module, the detector module, or the test cell module without departing from the scope and spirit of the disclosure and claims contained herein.

While the terms “light” and “light beam” are used, it should be recognized that “light” corresponds to a range of electromagnetic energies that extends beyond wavelengths that may be typically detected by human vision. Except where noted, “light” should be read to encompass a range of wavelengths broader than the visible spectrum.

As such, the scope of the invention described herein shall be limited only by the claims.

What is claimed is:

1. A system for analyzing one or more characteristics of a test fluid comprising:
a beam scanner operable to emit a resonantly scanned beam of light;
a test cell adapted to receive a microarray having a surface reagent and aligned to receive the resonantly scanned beam of light from the beam scanner module and couple the scanned beam of light to the microarray; and
a detector aligned to receive light from the test cell and operable to measure the intensity of light received from the test cell.

2. The system of claim 1 wherein the beam scanner comprises:
at least one light source operable to produce a beam of light at a first wavelength;
a beam shaping optic aligned to receive the beam of light at the first wavelength and shape the beam; and
a MEMS scanner aligned to received the beam and operable to scan the beam in two dimensions;
wherein the MEMS scanner is operable to scan the beam resonantly in at least one of the dimensions.

3. The system of claim 2 wherein the at least one light source includes a laser emitter.

4. The system of claim 1 wherein the beam scanner comprises at least one light source operable to produce a beam of light at a plurality of wavelengths.

5. The system of claim 4 wherein the at least one light source includes a frequency-agile laser emitter.

6. The system of claim 4 wherein the at least one light source includes a plurality of laser emitters operable to produce a beam of light at a plurality of wavelengths.

7. The system of claim 6 wherein the beam scanner further comprises a beam combiner aligned to receive a plurality of beams from the plurality of laser emitters and combine the plurality of beams into a composite beam containing the plurality of wavelengths.

8. The system of claim 1 wherein the detector is further operable to detect variations in intensity arising from the resonantly scanned beam traversing an optical indicia.

9. The system of claim 8 further comprising a decoder coupled to the detector and operable to decode data corresponding to the optical indicia.

10. The system of claim 9 further comprising a controller operable to select the operation of the beam scanner responsive to the decoded data.

11. The system of claim 9 further comprising a controller operable to select an interpretation of intensity variations received by the detector responsive to the decoded data.

12. The system of claim 1 wherein the detector includes a focal plane detector aligned to receive light from the test cell module.

13. The system of claim 1 wherein the detector includes a non-imaging detector aligned to receive light from the test cell module.

14. The system of claim 13 further comprising a beam location feedback circuit operable to correlate received light to a beam location.

15. The system of claim 1 wherein the detector is operable to measure the intensity of light corresponding to surface plasmon resonance at the microarray.

16. The system of claim 1 wherein the detector is operable to measure the intensity of light corresponding to photoluminescence at the microarray.

17. The system of claim 1 wherein the detector is operable to measure the intensity of light corresponding to chemiluminescence at the microarray.

18. A method for interrogating a microarray comprising the steps of:
resonantly scanning a beam of light across a surface of a microarray; and
detecting light scattered from the resonantly scanned beam by the microarray.

19. The method of claim 18 wherein the scattered light includes reflected light.

20. The method of claim 18 wherein the step of detecting light includes detecting a variation in scattered light intensity corresponding to a variation in a concentration of at least one type of molecule captured by the microarray.

21. The method of claim 18 wherein the step of detecting light includes detecting a variation in scattering angle corresponding to a variation in a concentration of at least one type of molecule captured by the microarray.

22. The method of claim 18 wherein the step of detecting light includes detecting a variation in scattered light polarization corresponding to a variation in a concentration of at least one type of molecule captured by the microarray.

23. The method of claim 18 wherein the scattered light includes photoluminescence.

24. The method of claim 23 wherein the step of detecting light includes detecting a variation in photoluminescence corresponding to a variation in a concentration of at least one type of molecule captured by the microarray.

25. The method of claim 18 wherein the step of resonantly scanning a beam of light includes scanning a beam of light with a MEMS scanner.

26. The method of claim 18 wherein the resonantly scanned beam of light includes a plurality of wavelengths and wherein the step of detecting light includes detecting light at a corresponding plurality of wavelengths.

27. The method of claim 18 wherein the scattered light includes light produced by surface plasmon resonance.

28. A microarray comprising:
a first surface configured to be interrogated by incident illumination; and
an optical indicia formed on the first surface, the optical indicia encoding data corresponding to the configuration of the microarray.
